(19) United States
(12) Patent Application Publication
(10) Pub. No.: US 2026/0113103 A1
(43) Pub. Date: Apr. 23, 2026

(54) SATELLITE COMMUNICATION METHOD

(71) Applicant: Beijing Xiaomi Mobile Software Co., Ltd., Beijing (CN)

(72) Inventors: Yuxin MAO, Beijing (CN); Yang SHEN, Beijing (CN)

(21) Appl. No.: 19/105,224

(22) PCT Filed: Aug. 22, 2022
(86) PCT No.: PCT/CN2022/114069

§ 371 Date: Feb. 20, 2025

(51) Int. Cl. H04B 7/185

(52) U.S. Cl. CPC H04B 7/18532; H04B 7/18539; H04B 7/18545

(57) ABSTRACT

A satellite communication method, includes: in response to receiving an access request message sent by a satellite terminal, a satellite equipment determines a first address corresponding to the satellite terminal, and sends an access response message to the satellite terminal, where the access response message includes the first address, the access response message is used to indicate the satellite terminal to communicate by means of a target transmission channel according to the first address, and the target transmission channel is a channel between the satellite equipment and a target communication network.

### CROSS-REFERENCE

The present application is a U.S. National Stage of International Application No. PCT/CN2022/114069, filed on Aug. 22, 2022, the contents of all of which are incorporated herein by reference in their entireties for all purposes.

### BACKGROUND OF THE PRESENT INVENTION

With the development of wireless communication technologies, the 3GPP (3rd Generation Partnership Project) has proposed a satellite access solution capable of providing a satellite terminal with access and communication functions through a terrestrial network which may include a 4G (the 4th Generation Mobile Communication Technology) network or a 5G (the 5th Generation Mobile Communication Technology) network.

### SUMMARY OF THE PRESENT INVENTION

According to a first aspect of the embodiments of the present disclosure, a satellite communication method is provided, performed by a satellite device. The method includes:
determining, in response to receiving an access request message sent by a satellite terminal, a first address corresponding to the satellite terminal; and
sending an access response message to the satellite terminal, where the access response message includes the first address and is used to indicate the satellite terminal to communicate through a target transmission channel according to the first address, the target transmission channel is a channel between the satellite device and a target communication network, the target communication network is a network supporting a preset communication standard, and the satellite terminal is a terminal not supporting a preset communication standard.

According to a second aspect of the embodiments of the present disclosure, a satellite communication method is provided, performed by an access network device in a target communication network, the target communication network further includes a core network device. The method includes:
forwarding messages for communication between a satellite device and the core network device, in order that facilitate the satellite device establishes a target transmission channel with the target communication network, determines, in response to receiving an access request message sent by a satellite terminal, a first address corresponding to the satellite terminal, and sends an access response message to the satellite terminal, where the access response message includes the first address, and is used to indicate the satellite terminal to access the target communication network according to the first address and communicate based on the target transmission channel; the target communication network is a network supporting a preset communication standard, and the satellite terminal is a terminal not supporting a preset communication standard.

According to a third aspect of the embodiments of the present disclosure, a satellite communication method is provided, performed by an access and mobility management function (AMF) entity, the AMF entity is an entity in a target communication network, the target communication network further includes an access network device. The method includes:
sending, in response to receiving a first channel establishment request message sent by a satellite device through the access network device, a second channel establishment request message to a session management function (SMF) entity in the target communication network; and
sending, in response to receiving a third message sent by the SMF entity, a first channel establishment acceptance message to the satellite device through the access network device, where the third message is a message sent by the SMF entity after a target transmission channel between the satellite device and the target communication network is established in response to the second channel establishment request message; the first channel establishment acceptance message is used to indicate the satellite device to determine the target transmission channel, to determine, in response to receiving an access request message sent by a satellite terminal, a first address corresponding to the satellite terminal, and to send an access response message to the satellite terminal, where the access response message includes the first address, and is used to indicate the satellite terminal to access according to the first address to communicate through the target transmission channel; the target communication network is a network supporting a preset communication standard, and the satellite terminal is a terminal not supporting a preset communication standard.

According to a fourth aspect of the embodiments of the present disclosure, a satellite communication device is provided, including:
a processor; and
a memory for storing processor-executable instructions;
where the processor is configured to perform the steps of the satellite communication method as provided in the first aspect of the present disclosure.

According to a fifth aspect of the embodiments of the present disclosure, a satellite communication device is provided, including:
a processor; and
a memory for storing processor-executable instructions;
where the processor is configured to perform the steps of the satellite communication method as provided in the second aspect of the present disclosure.

According to a sixth aspect of the embodiments of the present disclosure, a satellite communication device is provided, including:
a processor; and
a memory for storing processor-executable instructions;
where the processor is configured to perform the steps of the satellite communication method as provided in the third aspect of the present disclosure.

It is to be understood that both the foregoing general description and the following detailed description are merely exemplary and explanatory, and are not restrictive of the present disclosure.

### BRIEF DESCRIPTION OF DRAWINGS

The accompanying drawings herein, which are incorporated into the specification and constitute a part of the specification, show the embodiments consistent with the present disclosure, and together with the specification, serve to explain the principles of the present disclosure.

FIG. 1 is a schematic diagram of a communication system as shown according to an example.

FIG. 2 is a schematic diagram of a communication system as shown according to an example.

FIG. 3 is a flowchart of a satellite communication method as shown according to an example.

FIG. 4 is a flowchart of a method of determining a target transmission channel as shown according to an example.

FIG. 5 is a flowchart of a method of determining a target transmission channel as shown according to an example.

FIG. 6 is a flowchart of a satellite communication method as shown according to an example.

FIG. 7 is a flowchart of a satellite communication method as shown according to an example.

FIG. 8 is a flowchart of a method of establishing a second interface as shown according to an example.

FIG. 9 is a flowchart of a satellite communication method as shown according to an example.

FIG. 10 is a flowchart of a satellite communication method as shown according to an example.

FIG. 11 is a flowchart of a method of establishing a second interface as shown according to an example.

FIG. 12 is a flowchart of a satellite communication method as shown according to an example.

FIG. 13 is a flowchart of a satellite communication method as shown according to an example.

FIG. 14 is a flowchart of a satellite communication method as shown according to an example.

FIG. 15 is a flowchart of a satellite communication method as shown according to an example.

FIG. 16 is a flowchart of a satellite communication method as shown according to an example.

FIG. 17 is a flowchart of a satellite communication method as shown according to an example.

FIG. 18 is a flowchart of a satellite communication method as shown according to an example.

FIG. 19 is a block diagram of a satellite communication device as shown according to an example.

FIG. 20 is a block diagram of a satellite communication device as shown according to an example.

FIG. 21 is a block diagram of a satellite communication device as shown according to an example.

FIG. 22 is a block diagram of a satellite communication device as shown according to an example.

FIG. 23 is a block diagram of a satellite communication device as shown according to an example.

FIG. 24 is a block diagram of a satellite communication device as shown according to an example.

FIG. 25 is a block diagram of a satellite communication device as shown according to an example.

### DETAILED DESCRIPTION OF THE PRESENT INVENTION

Here, examples will be illustrated in detail, examples of which are expressed in the accompanying drawings. When the following description refers to the accompanying drawings, unless otherwise indicated, like numbers in various accompanying drawings represent like or similar elements. The implementations as described in the following examples do not represent all the implementations consistent with the present disclosure, and rather, are merely examples of devices and methods consistent with some aspects of the present disclosure as detailed in the appended claims.

It is to be noted that all the actions of acquiring signals, information or data in the present disclosure are carried out under the premise of complying with the corresponding data protection regulations and policies of the located country and in the case of obtaining the authorization from the owner of the corresponding device.

In the description of the present disclosure, the used terms such as “first” and “second” are used to distinguish between similar objects, without necessarily being understood as a specific sequence or order. Additionally, without making contrary illustrations, in the description with reference to the accompanying drawings, the same reference numeral in various drawings represents the same elements.

In the description of the present disclosure, unless otherwise stated, “a plurality of” refers to two or more, and other quantifiers are similar thereto; and “at least one of”, “one or more” or similar expressions refer to any combination of the listed items, including any combination of singular items or plural items. For example, at least one a can mean any number of a. For another example, one or more of a, b and c can mean: a, b, c, a-b, a-c, b-c, or a-b-c, where a, b and c can be single or multiple. “And/or” is an association that describes the associated objects, meaning that there can be three relationships. For example, A and/or B, can mean three cases, i.e., A alone, both A and B, and B alone, where A and B can be singular or plural.

Although the operations or steps are described in a specific sequence in the accompanying drawings in the embodiments of the present disclosure, it is not to be understood as requiring that these operations or steps be performed in the shown specific sequence or a serial sequence, or as requiring that all the shown operations or steps be performed to achieve the desired results. In the embodiments of the present disclosure, these operations or steps can be performed in series; or these operations or steps can be performed in parallel; or a part of these operations or steps can be performed.

In the related technologies, in order to access the satellite terminal to the terrestrial network, the satellite terminal needs to be upgraded, so that the satellite terminal supports a communication standard (e.g., 4G or 5G technology) corresponding to the terrestrial network.

The present disclosure relates to the technical field of communications, and specifically to a satellite communication method.

Firstly, the implementation environment of the embodiments of the present disclosure will be introduced below.

The technical solution of the embodiments of the present disclosure can be performed by various communication systems. The communication systems may include one or more of a 4G (the 4th Generation) communication system, a 5G (the 5th Generation) communication system, and other future wireless communication systems (such as 6G). The communication systems may also include one or more of a Public Land Mobile Network (PLMN) network, a Device-to-Device (D2D) communication system, a Machine-to-Machine (M2M) communication system, an Internet of Things (IoT) communication system, a Vehicle-to-Everything (V2X) communication system, or other communication systems.

FIG. 1 is a schematic diagram of a communication system as shown according to an example. As shown in FIG. 1, the communication system may include a satellite device 150, an access network device 160, a core network device 170, and a satellite terminal 180. In the communication system, the number of the satellite terminal, satellite device, access network device and core network device may each be one or more. The number of the satellite terminal, satellite device, access network device and core network device in the communication system as shown in FIG. 1 is merely an adaptive example, which is not limited by the present disclosure. Satellite terminal and satellite terminal, satellite device and satellite device, access network device and access network device, and core network device and core network device can each be connected with each other by wired or wireless means.

In some embodiments, the access network device and the core network device can compose a target communication network, the target communication network can be a network supporting a preset communication standard. For example, the preset communication standard may include a 4G network access standard such as Long Term Evolution (LTE) access technology, or a 5G network access standard such as New Radio Access Technology (New RAT), or other future wireless communication standards (such as 6G). The access network device may be connected to the core network device by wireless or wired means. The core network device and the access network device may be independent and different physical devices, or the functions of the core network device and the logical functions of the access network device may be integrated onto the same physical device, or part of the functions of the core network device and part of the functions of the access network device may be integrated onto one physical device. It is to be noted that in addition to the above access network device and core network device, the target communication network may include other communication devices, such as a wired or wireless backhaul device and an operation and maintenance device, which is not limited by the present disclosure.

The access network device in FIG. 1 may be used to support access by the satellite device. For example, the access network device can be an evolved Node B (eNB or eNodeB) in LTE; or can be the next Generation Node B (gNB or gNodeB) in a 5G network; or can be an NG Radio Access Network (NG-RAN) device in a 5G network; or can be a base station, a Broadband Network Gateway (BNG), a convergence switch, or a non-3GPP (3rd Generation Partnership Project) access device, and the like in the future evolution of Public Land Mobile Network (PLMN). Optionally, the access network device in the embodiments of the present disclosure may include various forms of base stations, such as a macro base station, a micro base station (also called a small station), a relay station, an access point, a 5G base station or future base station, a satellite, a Transmitting and Receiving Point (TRP), a Transmitting Point (TP), a mobile switching center, and a device that plays the role of a base station in Device-to-Device (D2D), Machine-to-Machine (M2M), Internet of Things (IoT), Vehicle-to-Everything (V2X) or other communication, which is not specifically limited by the embodiments of the present disclosure. For convenience of description, in all embodiments of the present disclosure, devices providing a satellite device with wireless communication functions are collectively referred to as an access network device or a base station.

The satellite device in FIG. 1 can communicate with the satellite terminal (e.g., communicate with the satellite terminal based on a satellite network), or can support to communicate with the target communication network (e.g., can support the preset communication standard corresponding to the target communication network and communicate with the target communication network based on the preset communication standard).

In some embodiments, the satellite device can be a satellite side or a ground side in the satellite network. The satellite network can be composed of three parts: a satellite side, a ground side, and a user side. The satellite side acts as a relay station in the air, that amplifies an electromagnetic wave sent from the ground side and then sends it back to another ground side. The satellite side may include a satellite body, which in turn includes two subsystems: an on-satellite device and a satellite parent. The ground side is an interface between a satellite system and a ground public network, and a ground user can also have an access to the satellite system through the ground side, thus forming a link. The ground side may further include a ground satellite control center and its tracking, telemetry and command station. The user side can be various user terminals. The satellite side can be an on-satellite aircraft carrying a bend payload or regenerative payload telecommunication transmitter, and is usually located in a Low-Earth Orbit (LEO) ranging from 300 km to 2,000 km, a Medium-Earth Orbit (MEO) ranging from 8,000 km to 20,000 km, or a Geostationary satellite Earth orbit (GEO) with an altitude of 35,786 km.

The satellite terminal in FIG. 1 can be a terminal device supporting satellite communication, for example, a terminal device having a function of communicating with the satellite device. The terminal device can be an electronic device providing voice or data connectivity. For example, the terminal device can also be called a User Equipment (UE), a Subscriber Unit, a Mobile Station, a Station, a Terminal, and the like. For example, the terminal device may include a smart phone, a smart wearable device, a smart speaker, a smart tablet, a wireless modem, a Wireless Local Loop (WLL) station, a PDA (Personal Digital Assistant), CPE (Customer Premise Equipment), and the like. With the development of wireless communication technologies, devices that can access a satellite device for communication, devices that can communicate with other objects through a communication system, or devices that can communicate directly between two or more of such devices can all be the satellite terminals in the embodiments of the present disclosure, such as terminals and cars in smart transportation, household devices in smart homes, power meters in smart grids, voltage monitors, environmental monitors, video monitors in smart security networks, and cash registers. In the embodiments of the present disclosure, the satellite terminal may be stationary, or may be mobile, which is not limited by the present disclosure.

In some embodiments, the satellite terminal may be a user side or a ground side in the above satellite network.

In some embodiments, the satellite terminal can support a satellite communication function (i.e., communication with the satellite device), but not support the preset communication standard corresponding to the above target communication network (i.e., direct communication with the above target communication network).

In other some embodiments, the satellite terminal can support both the satellite communication function (i.e., communication with the satellite device) and the preset communication standard corresponding to the above target communication network (i.e., direct communication with the above target communication network).

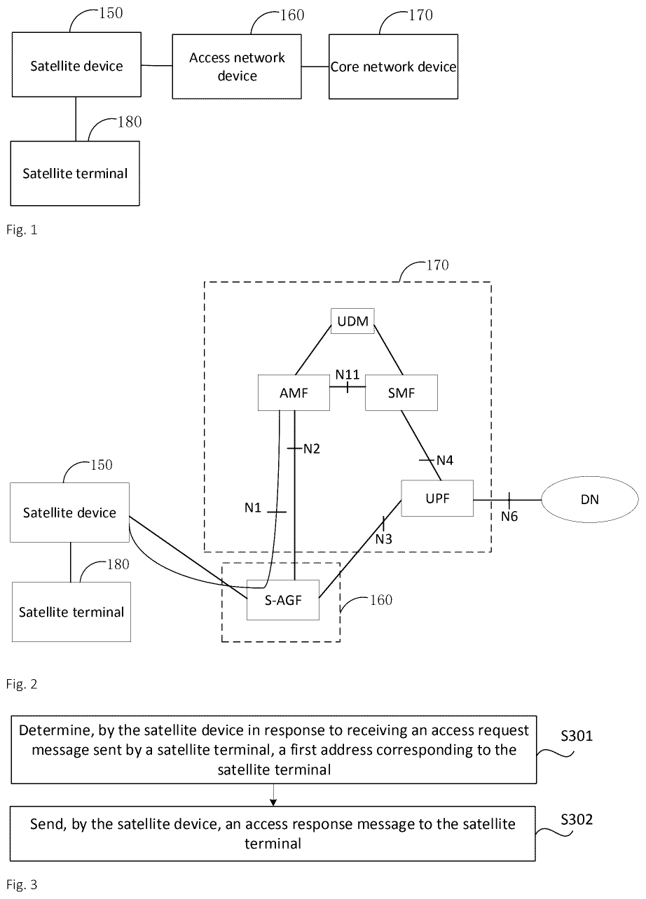

FIG. 2 is a schematic diagram of another communication system as shown according to an example. As shown in FIG. 2, the access network device 160 in the communication system may include a satellite access gateway function (S-AGF) entity, the S-AGF entity may be used to provide the satellite device with an access and communication function. The core network device 170 may include one or more entities. For example, the core network device 170 may include an AMF (Access and Mobility Management Function) entity, an SMF (Session Management Function) entity, a UDM (Unified Data Management) entity, and a UPF (User Plane Function) entity. Additionally, the communication system may further include a DN (Data Network). The specific functions and implementations with respect to the above AMF, SMF, UDM, UPF and DN can refer to the relevant descriptions in the 3GPP protocol, which will not be detailed by the present disclosure.

It is to be noted that the entities as shown in FIG. 2 can be hardware, or functionally divided software, or a structure combing both.

FIG. 3 is a satellite communication method as shown according to an example. The method can be performed by a satellite device in the above communication system. As shown in FIG. 3, the method may include steps S301 and S302.

S301: The satellite device determines, in response to receiving an access request message sent by a satellite terminal, a first address corresponding to the satellite terminal.

The access request message may be used to indicate the satellite terminal to request an access to the satellite device for communication. The first address may be an address for communicate between the satellite terminal and the satellite device.

In some embodiments, the satellite device may act as a specific 3GPP terminal device that accesses the target communication network (e.g., 5G network). For example, in the case where the target communication network is a 5G network, the satellite device may be a 5G satellite, and the interface between the satellite device and the core network device may be an N1 interface.

In some embodiments, the satellite device may act as a first hop route or a default route for the satellite device, and may allocate the first address to the satellite terminal. In the case of a plurality of satellite terminals, the satellite devices may allocate different first addresses to different satellite terminals.

In some embodiments, the first address may be an IP (Internet Protocol) address, for example, an IPV4 (Internet Protocol version 4) address or an IPV6 (Internet Protocol version 6) address. Indeed, there may be two IP addresses, including, for example, both the IPV4 address and the IPV6 address.

For example, the first address may be a local IP address or a private IP address, i.e., a private network IP address inside the satellite device. For another example, the first address may also be a public network IP address.

In some other embodiments, the first address may be a satellite terminal identity, the satellite terminal identity is used to uniquely identify one satellite terminal among a plurality of satellite terminals in communication with the satellite, in order that facilitate the satellite terminal communicates with the satellite device.

S302: The satellite device sends an access response message to the satellite terminal.

The access response message may include the first address, and may be used to indicate the satellite terminal to communicate through a target transmission channel according to the first address; and the target transmission channel is a channel between the satellite device and the target communication network.

For example, the satellite device may receive the access request message sent by the satellite terminal through the satellite network, or may send an access response message to the satellite terminal through the satellite network.

In some embodiments, the target communication network may be a network supporting a preset communication standard, and the satellite terminal may be a terminal not supporting a preset communication standard.

In some other embodiments, the target communication network and the satellite terminal may each support a preset communication standard.

The preset communication standard may include 4G, 5G or other future wireless communication standards (such as 6G).

With the above method, a satellite device determines, in response to receiving an access request message sent by a satellite terminal, a first address corresponding to the satellite terminal, and sends an access response message to the satellite terminal. The access response message includes the first address, and may be used to indicate the satellite terminal to communicate through a target transmission channel according to the first address; and the target transmission channel is a channel between the satellite device and a target communication network. In this way, the satellite device can determine the first address corresponding to the satellite terminal and send the first address to the satellite terminal, in order that facilitate the satellite terminal communicates through the target transmission channel between the satellite device and the target communication network according to the first address. With this method, in the case where the satellite terminal does not support the preset network standard corresponding to the target communication network, the satellite terminal can still communicate through the target transmission channel between the satellite device and the target communication network, so that the traditional satellite terminal not supporting the preset network standard can be compatible with, thus expanding the application range of the target communication network.

In some embodiments of the present disclosure, the above target transmission channel may be a PDU (Protocol Data Unit) session, or may be a data transmission channel based on the PDU session.

It is to be noted that in the embodiments of the present disclosure, the transmission channels can each be a PDU session. For example, in the case where the target communication network is a 5G network, the target transmission channel may be a target PDU session in the 5G network.

In some embodiments, the above target transmission channel may be a channel established by the satellite device in response to receiving the access request message sent by the satellite terminal.

In some other embodiments, the above target transmission channel may be a channel that has been successfully established by the satellite device before the access request message sent by the satellite terminal is received, and after the access request message sent by the satellite terminal is received, the satellite device may take the already successfully established channel as the target transmission channel.

In some other embodiments, if the satellite device has established one or more pending transmission channels, in the case where the access request message sent by the satellite terminal is received, the satellite device may select at least one pending transmission channel from the one or more pending transmission channels as the target transmission channel; or the satellite device may establish a new transmission channel for the satellite terminal as the target transmission channel.

In some embodiments, the target transmission channel may be a transmission channel dedicated to the satellite terminal. For example, the target transmission channel may be a transmission channel dedicated to a certain satellite terminal, or may be a transmission channel dedicated to a plurality of satellite terminals, which the non-satellite terminals do not use.

In some other embodiments, the target transmission channel may also be a transmission channel shared by a satellite terminal and a non-satellite terminal.

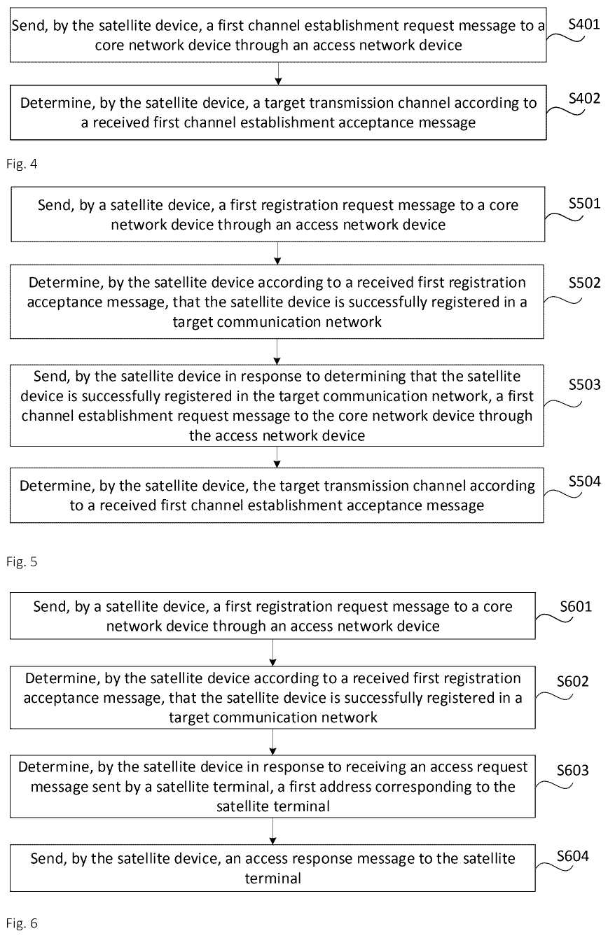

FIG. 4 is a method of determining a target transmission channel as shown according to an example. The method can be performed by a satellite device in the above communication system. As shown in FIG. 4, the method may include steps S401 and S402.

S401: The satellite device sends a first channel establishment request message to a core network device through an access network device.

S402: The satellite device determines a target transmission channel according to a received first channel establishment acceptance message.

The first channel establishment acceptance message is a message sent by the core network device through the access network device after the target transmission channel is successfully established for the satellite device in response to the first channel establishment request message.

In this way, the satellite device can exchange messages with the core network device, thus determining the target transmission channel.

In some embodiments, the above target transmission channel may be a target PDU session, or may be a data transmission channel based on the PDU session. The above first channel establishment request message may be a first PDU session establishment request message (e.g., PDU Session Establishment Request), and the above first channel establishment acceptance message may be a first PDU session establishment acceptance message (e.g., PDU Session Establishment Accept).

In some embodiments, the above first channel establishment request message may include a first preset device identity, the first preset device identity is used to indicate that the satellite device has a function to allocate a first address to a satellite terminal and provide the satellite terminal with the target transmission channel for communication.

For example, the first preset device identity may be a 5G-satellite UE indication. Any satellite device with the function of allocating the first address to the satellite terminal and providing the satellite terminal with the target transmission channel for communication can carry the first preset device identity in the first channel establishment request message.

Likewise, the above first channel establishment acceptance message may or may not carry the first preset device identity, which is not limited by the present disclosure.

In some embodiments of the present disclosure, the above first channel establishment acceptance message may include a second address allocated by the core network device to the satellite device. In this way, the satellite device can determine the first address corresponding to the satellite terminal by:
allocating the first address to the satellite device according to the second address. The first address and the second address may be different or the same.

In some implementations, the second address may include an IP address and/or an IP address prefix.

For example, the second address may include any one or more of an IPV4 address, an IPV6 address, an IPV4 address prefix, and an IPV6 address prefix.

In the case where the second address is an IP address prefix, the satellite device may use an IP address segment corresponding to the IP address prefix.

In some implementations, the above first address may be a local IP address or a private IP address.

For example, in the case where the second address of the satellite device is an IP address, the satellite device may select one address from the preset local IP address or private IP address as the first address, and allocate the first address to the satellite terminal.

In some other implementations, the above first address may also be a public network IP address.

For example, in the case where the second address of the satellite device is an IP address prefix (e.g., IPV6 address prefix), the satellite device may select one IP address from the IP address segments corresponding to the IP address prefix as the first address allocated to the satellite terminal.

In some embodiments of the present disclosure, the satellite device may determine, in the case of a successful registration, the above target transmission channel. If the satellite device is not successfully registered, the registration may be firstly carried out, and then the target transmission channel may be determined in the case of a successful registration.

FIG. 5 is another method of determining a target transmission channel as shown according to an example. As shown in FIG. 5, the method may include steps S501-S504.

S501: A satellite device sends a first registration request message to a core network device through an access network device.

S502: The satellite device determines, according to a received first registration acceptance message, that the satellite device is successfully registered in a target communication network.

The first registration acceptance message is a message sent by the core network device to the satellite device through the access network device after the satellite device is successfully registered in response to the first registration request message.

S503: The satellite device sends, in response to determining that the satellite device is successfully registered in the target communication network, a first channel establishment request message to the core network device through the access network device.

S504: The satellite device determines the target transmission channel according to a received first channel establishment acceptance message.

The first channel establishment acceptance message is a message sent by the core network device through the access network device after the target transmission channel is successfully established for the satellite device in response to the first channel establishment request message.

In this way, the satellite device can accomplish the registration in the target communication network, and establish the target transmission channel.

In some embodiments, the above first registration request message includes a second preset device identity, the second preset device identity may be used to indicate that the satellite device has a function to allocate a first address to a satellite terminal and provide the satellite terminal with the target transmission channel for communication.

It is to be noted that the second preset device identity may be the same as or different from the first preset device identity. For example, the second preset device identity may also be a 5G-satellite UE indication.

In some embodiments, the above first registration request message and first channel establishment request message may each carry a preset device identity. Likewise, the preset device identity may be used to indicate that the satellite device has a function to allocate the first address to the satellite terminal and provide the satellite terminal with the target transmission channel for communication. For example, the preset device identity may be a 5G-satellite UE indication.

In some other embodiments, the preset device identity may be carried in the above first registration request message, and the preset device identity may not be carried in the first channel establishment request message. The above first registration request message and first channel establishment request message may each carry a satellite device identity for uniquely identifying one satellite device, so that the core network device can determine, with the satellite device identity, whether the satellite device has the function of allocating the first address to the satellite terminal and providing the satellite terminal with the target transmission channel for communication.

In some other embodiments, the preset device identity may be carried in the above first channel establishment request message, and the preset device identity may not be carried in the first registration request message.

In some embodiments of the present disclosure, the above access network device may include a satellite access gateway function (S-AGF) entity, and the above core network device may include an access and mobility management function (AMF) entity.

The S-AGF entity may be used to provide the satellite device with an access and communication function. The S-AGF entity may establish a control plane interface with the AMF entity, for example, the control plane interface may be an N2 interface. The satellite device may establish an N1 interface with the AMF entity through the S-AGF entity.

In some embodiments, the core network device may further include a UPF entity, and the S-AGF entity may establish a user plane interface with the UPF entity, such as an N3 interface.

FIG. 6 is a satellite communication method as shown according to an example. As shown in FIG. 6, the method may include steps S601-S603.

S601: A satellite device sends a first registration request message to a core network device through an access network device.

S602: The satellite device determines, according to a received first registration acceptance message, that the satellite device is successfully registered in a target communication network.

It is to be noted that in this embodiment, the implementation of sending the first registration request message and receiving the first registration acceptance message by the satellite device can refer to the description in the previous embodiments of the present disclosure, and will not be detailed herein.

S603: The satellite device determines, in response to receiving an access request message sent by a satellite terminal, a first address corresponding to the satellite terminal.

In some embodiments, the satellite device may firstly determine whether a target transmission channel exists between the satellite device and the target communication network, and in the case where the target transmission channel exists, may directly determine the first address corresponding to the satellite terminal (e.g., allocate the first address to the satellite terminal); or, in the case where no target transmission channel exists, the satellite device may firstly determine the target transmission channel (e.g., establish the target transmission channel), and then determine the first address corresponding to the satellite terminal.

In some other embodiments, in the case where no target transmission channel exists, the satellite device may firstly determine the first address corresponding to the satellite terminal (e.g., allocate the first address to the satellite terminal), and then determine the target transmission channel (e.g., establish the target transmission channel).

In some other embodiments, the satellite device may also in parallel perform the steps of determining the target transmission channel and determining the first address.

It is to be noted that the implementation of determining the target transmission channel by the satellite terminal can refer to the method as shown in the embodiment of FIG. 4, and will not be detailed herein.

S604: The satellite device sends an access response message to the satellite terminal.

The access response message may include the first address, and may be used to indicate the satellite terminal to communicate through the above target transmission channel according to the first address.

In this way, the satellite device can register in the target communication network, determine the target transmission channel, and allocate the first address to the satellite terminal, in order to support the satellite terminal to communicate through the target transmission channel according to the first address.

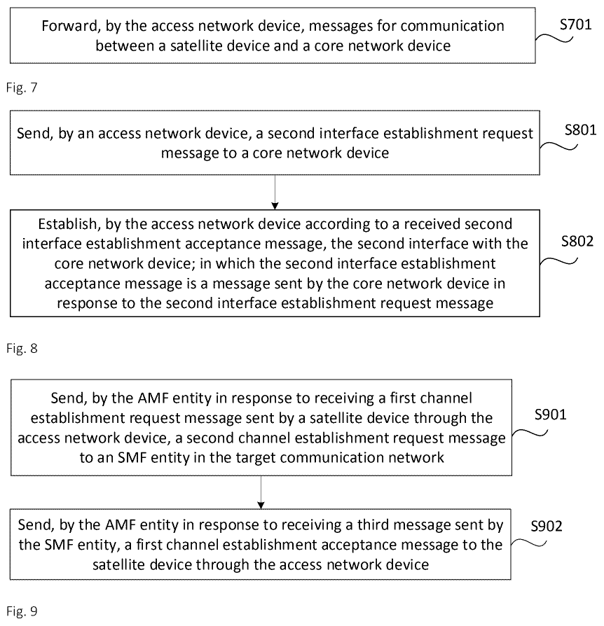

FIG. 7 is a satellite communication method as shown according to an example. The method can be performed by an access network device in the above communication system. As shown in FIG. 7, the method may include step S701.

S701: The access network device forwards messages for communication between a satellite device and a core network device.

In this way, by forwarding messages, the satellite device can be caused to establish a target transmission channel with a target communication network, and to determine, in response to receiving an access request message sent by a satellite terminal, a first address corresponding to the satellite terminal, and send an access response message to the satellite terminal, where the access response message includes the first address, and is used to indicate the satellite terminal to access the target communication network according to the first address and communicate based on the target transmission channel; the target communication network is a network supporting a preset communication standard, and the satellite terminal is a terminal not supporting a preset communication standard.

With the above implementation, by forwarding messages for communication between the satellite device and the core network device, the satellite device can be supported to establish the target transmission channel with the target communication network, and the satellite terminal can be allocated the first address, so that the satellite terminal can be supported to communicate through the target transmission channel between the satellite device and the target communication network according to the first address. With this method, in the case where the satellite terminal does not support the preset network standard corresponding to the target communication network, the satellite terminal can still communicate through the target transmission channel between the satellite device and the target communication network, so that the traditional satellite terminal not supporting the preset network standard can be compatible with, thus expanding the application range of the target communication network.

In some embodiments, the implementations of forwarding messages in step S701 may include any one or more of:

Forwarding Implementation 1: forwarding, in response to receiving a first message sent by the satellite device, the first message to the core network device in the target communication network.

The first message may include any one or more of a first registration request message, a first channel establishment request message, and other control messages.

In some embodiments, the core network device may include an AMF entity, and the first message may be forwarded to the AMF entity.

Forward Implementation 2: forwarding, in response to receiving a second message sent by the core network device, the second message to the satellite device.

The second message includes any one or more of a first registration acceptance message, a first channel establishment acceptance message, and other control messages.

In some embodiments, the core network device may include an AMF entity, and the second message may be a message sent by the AMF entity to the satellite device.

Forward Implementation 3: forwarding, in response to receiving a first data packet sent by the satellite device, the first data packet to the core network device in the target communication network.

In some embodiments, the core network device may include an UPF entity, and the first data packet may be forwarded to the UPF entity.

In some embodiments, the first data packet may be a data packet sent by the satellite device through the target transmission channel between the satellite device and the target communication network. The target transmission channel may be a target PDU session, or a data transmission channel based on the target PDU session.

Forward Implementation 4: forwarding, in response to receiving a second data packet sent by the core network device, the second data packet to the satellite device.

In some embodiments, the core network device may include an UPF entity, and the second data packet may be a data packet sent by the UPF entity to the satellite device.

In some embodiments, the second data packet may be a data packet sent by the core network device through the target transmission channel between the satellite device and the target communication network. The target transmission channel may be a target PDU session, or a data transmission channel based on the target PDU session.

In some embodiments of the present disclosure, the access network device may establish, before forwarding messages for communication between the satellite device and the core network device, a second interface with the core network device. For example, the access network device may forward, in response to determining that the second interface is established with the core network device, messages for communication between the satellite device and the core network device. For example, in the case where the target communication network is a 5G network, the second interface may be an N2 interface.

FIG. 8 is a method of establishing a second interface as shown according to an example. As shown in FIG. 8, the method may include steps S801 and S802.

S801: An access network device sends a second interface establishment request message to a core network device.

In some embodiments, the access network device may determine a core network device address of the core network device, and send a second interface establishment request message to the core network device according to the core network device address of the core network device. The core network device address may be an address pre-configured by the access network device.

S802: The access network device establishes, according to a received second interface establishment acceptance message, the second interface with the core network device, where the second interface establishment acceptance message is a message sent by the core network device in response to the second interface establishment request message.

In some embodiments, the above core network device may include an access and mobility management function (AMF) entity, and the access network device may establish the above second interface (e.g., N2 interface) with the AMF entity. For example, the access network device may send the second interface establishment request message to the AMF entity, and establish the second interface with the AMF entity according to a received second interface establishment acceptance message.

The second interface establishment acceptance message is a message sent by the AMF entity in response to the second interface establishment request message.

In some embodiments, the access network device may determine an AMF entity address of the AMF entity, and send the second interface establishment request message to the AMF entity according to the AMF entity address of the AMF entity. The AMF entity address may be an address pre-configured by the access network device.

Taking the target communication network being a 5G network as an example, the second interface may be an N2 interface between the access network device and the AMF entity, the second interface establishment request message may be an N2 interface establishment request message, and the second interface establishment acceptance message may be an N2 interface establishment acceptance message.

In some embodiments, the access network device may include a satellite access gateway function (S-AGF) entity, and the above second interface establishment request message may include a gateway node indication, the gateway node indication is used to indicate the access network device provides a gateway function for the satellite device

FIG. 9 is a satellite communication method as shown according to an example. The method can be performed by an AMF entity in the above communication system, the AMF entity is an entity in a target communication network, and the target communication network further includes an access network device. As shown in FIG. 9, the method may include steps S901 and S902.

S901: The AMF entity sends, in response to receiving a first channel establishment request message sent by a satellite device through the access network device, a second channel establishment request message to a session management function (SMF) entity in the target communication network.

S902: The AMF entity sends, in response to receiving a third message sent by the SMF entity, a first channel establishment acceptance message to the satellite device through the access network device.

The third message is a message sent by the SMF entity after a target transmission channel between the satellite device and the target communication network is established in response to the second channel establishment request message. The first channel establishment acceptance message is used to indicate the satellite device to determine the target transmission channel, to determine, in response to receiving an access request message sent by a satellite terminal, a first address corresponding to the satellite terminal, and send an access response message to the satellite terminal, where the access response message includes the first address, and is used to indicate the satellite terminal to access according to the first address to communicate through the target transmission channel; the target communication network is a network supporting a preset communication standard, and the satellite terminal is a terminal not supporting a preset communication standard.

With the above implementation, the AMF entity can establish, in response to receiving the first channel establishment request message sent by the satellite device through the access network device, the target transmission channel for the satellite device by interacting with the SMF entity, in order that facilitate the satellite device provides the satellite terminal with communication services through the target transmission channel.

In some embodiments, the above third message and first channel establishment acceptance message may each include a second address allocated by the core network device to the satellite device.

In some implementations, the second address may include an IP address and/or an IP address prefix.

For example, the second address may include any one or more of an IPV4 address, an IPV6 address, an IPV4 address prefix, and an IPV6 address prefix.

In the case where the second address is an IP address prefix, the satellite device may use an IP address segment corresponding to the IP address prefix.

In some embodiments, the AMF entity may further receive a second channel establishment response message sent by the SMF entity. The second channel establishment response message may characterize the SMF entity as having received the first channel establishment request message.

In some embodiments, the above target transmission channel may be a target PDU session, or may be a data transmission channel based on the PDU session. The above first channel establishment request message may be a first PDU session establishment request message (e.g., PDU Session Establishment Request), and the above first channel establishment acceptance message may be a first PDU session establishment acceptance message (e.g., PDU Session Establishment Accept). The above second channel establishment request message may be a second PDU session establishment request message (e.g., Nsmf_PDUSession_CreateSMContext Request), and the above second channel establishment response message may be a second PDU session establishment response message (e.g., smf_PDUSession_CreateSMContext Response). The above third message may be an N1N2 transfer message (e.g., Namf_Communication_N1N2Message Transfer).

In some embodiments, the above first channel establishment request message may include a first preset device identity. The first preset device identity is used to indicate that the satellite device has a function to allocate the first address to the satellite terminal and provide the satellite terminal with the target transmission channel for communication. For example, the first preset device identity may be a 5G-satellite UE indication. Any satellite device with the function of allocating the first address to the satellite terminal and providing the satellite terminal with the target transmission channel for communication can carry the first preset device identity in the first channel establishment request message.

In some other embodiments, the above second channel establishment request message may include the first preset device identity.

In some other embodiments, the above first channel establishment request message and second channel establishment request message may each include a first preset device identity.

In some embodiments of the present disclosure, the above second channel establishment request message includes an access type and/or RAT (Radio Access Type) type. The access type may be used to characterize the type of the satellite device or satellite terminal, and the RAT type may be used to characterize the communication standard supported by the satellite device or the communication standard supported by the satellite terminal.

In some embodiments, the above second channel establishment request message may include an access type, the access type may include a first access type or a second access type. The first access type may be used to characterize a non-3GPP type (e.g., the first access type may be Non-3GPP Access), and the second access type may be used to characterize a 3GPP type (e.g., the second access type may be 3GPP Access).

In some other embodiments, the above second channel establishment request message may include a RAT type, the RAT type may include a first RAT type or a second RAT type. The first RAT type may be used to characterize a satellite communication standard (e.g., the first RAT type may be Legacy Satellite), and the second RAT type may be used to characterize a target communication standard (e.g., the second RAT type may be 5G Satellite or NR Satellite).

In some other embodiments, the above second channel establishment request message may include an access type and a RAT type.

In an implementation, the first access type may be used to characterize a non-3GPP type (e.g., the first access type may be Non-3GPP Access), and the first RAT type may be used to characterize a satellite communication standard (e.g., the first RAT type may be Legacy Satellite).

In another implementation, the second access type may be used to characterize a 3GPP type (e.g., the second access type is 3GPP Access), and the second RAT type may be used to characterize a target communication standard (e.g., the second RAT type may be 5G Satellite or NR Satellite).

In this way, the AMF entity can notify, through the access type and/or RAT type in the above second channel establishment request message, the SMF entity of the channel type to be established.

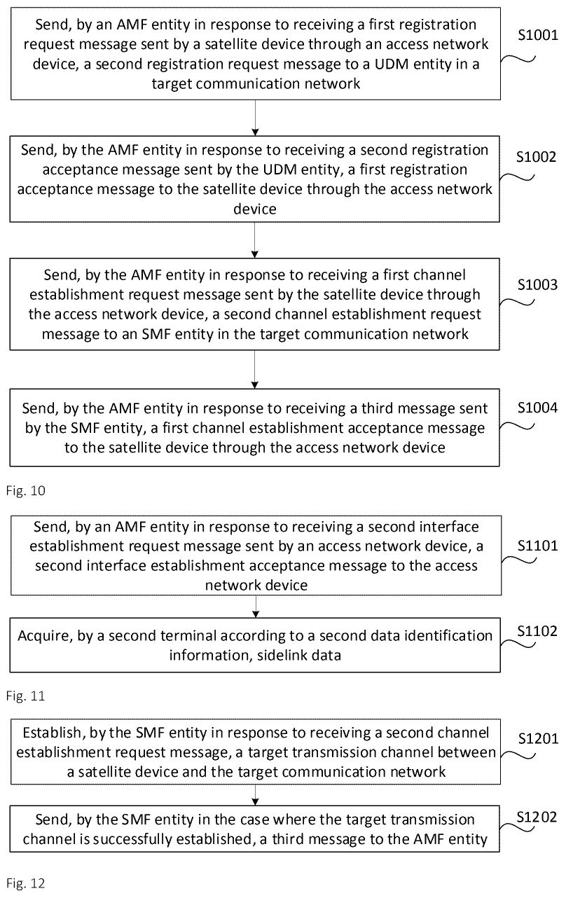

FIG. 10 is a satellite communication method as shown according to an example. As shown in FIG. 10, the method may include steps S1001-S1004.

S1001: An AMF entity sends, in response to receiving a first registration request message sent by a satellite device through an access network device, a second registration request message to a unified data management (UDM) entity in a target communication network.

S1002: The AMF entity sends, in response to receiving a second registration acceptance message sent by the UDM entity, a first registration acceptance message to the satellite device through the access network device.

The second registration acceptance message may be a message sent by the UDM entity in the case where the satellite device is successfully registered in response to the second registration request message; and the first registration acceptance message is used to indicate that the satellite device is successfully registered in the target communication network, in order that facilitate the satellite device sends, in the case of a successful registration, a first channel establishment request message to a core network device through the access network device.

In some embodiments, in the case where the second registration acceptance message sent by the UDM entity is received, the AMF entity may further determine whether subscription information for the satellite device is acquired in the AMF entity (e.g., whether a subscription for the satellite device is stored in the AMF entity), and may send, in the case where the AMF entity does not acquire the subscription information for the satellite device, a subscription information request message to the UDM entity; and acquire, in response to receiving a subscription information response message sent by the UDM entity, the subscription information for the satellite device, where the subscription information response message is a message sent by the UDM entity in response to the subscription information request message.

In some embodiments, the above first registration request message, second registration request message and subscription information request message may each include a second preset device identity, the second preset device identity may be used to indicate that the satellite device has a function to allocate a first address to a satellite terminal and provide the satellite terminal with the target transmission channel for communication.

It is to be noted that the second preset device identity may be the same as or different from the first preset device identity. For example, the second preset device identity may also be a 5G-satellite UE indication.

In some other embodiments, at least one or more of the above first registration request message, second registration request message and subscription information request message may carry the above second preset device identity.

In some embodiments, the subscription information for the satellite device may also include the above second preset device identity, and the AMF entity may determine, according to the subscription information for the satellite device and the first registration request message for the satellite device, whether the satellite device is successfully registered. For example, if the first registration request message carries the above second preset device identity, and the subscription information for the satellite device does not include the second preset device identity, it may be determined that the registration of the satellite device has failed; conversely, if both the first registration request message and the subscription information for the satellite device include the above second preset device identity, the satellite device may be successfully registered.

S1003: The AMF entity sends, in response to receiving a first channel establishment request message sent by the satellite device through the access network device, a second channel establishment request message to an SMF entity in the target communication network.

S1004: The AMF entity sends, in response to receiving a third message sent by the SMF entity, a first channel establishment acceptance message to the satellite device through the access network device.

With the above implementation, the AMF entity can register the satellite device and establish the target transmission channel, in order that facilitate the satellite device provides the satellite terminal with communication services through the target transmission channel.

In some embodiments of the present disclosure, in order to realize forwarding of messages for communication between the satellite device and the core network device by the access network device, the AMF entity can support the establishment of the second interface with the access network device.

FIG. 11 is a method of establishing a second interface as shown according to an example. As shown in FIG. 11, the method may include step S1101.

S1101: An AMF entity sends, in response to receiving a second interface establishment request message sent by an access network device, a second interface establishment acceptance message to the access network device.

Taking the target communication network being a 5G network as an example, the second interface may be an N2 interface between the access network device and the AMF entity, the second interface establishment request message may be an N2 interface establishment request message, and the second interface establishment acceptance message may be an N2 interface establishment acceptance message.

In some embodiments, the access network device may include a satellite access gateway function (S-AGF) entity, and the above second interface establishment request message may include a gateway node indication, the gateway node indication is used to indicate the access network device provides a gateway function for the satellite device. For example, the gateway node indication may be an S-AGF node indication.

In this way, the access network device can establish the second interface with the AMF entity, in order to forward the messages for communication between the satellite device and the core network device.

FIG. 12 is a satellite communication method as shown according to an example. The method can be performed by an SMF entity in the above communication system, the SMF entity is an entity in a target communication network, and the target communication network may further include an access network device. As shown in FIG. 12, the method may include steps S1201 and S1202.

S1201: The SMF entity establishes, in response to receiving a second channel establishment request message, a target transmission channel between a satellite device and the target communication network.

The second channel establishment request message is a message sent by an access and mobility management function (AMF) entity in the target communication network in response to receiving a first channel establishment request message sent by the satellite device through the access network device, for establishing the target transmission channel between the satellite device and the target communication network.

In some embodiments, the above first channel establishment request message may include a first preset device identity. The first preset device identity is used to indicate that the satellite device has a function to allocate a first address to a satellite terminal and provide the satellite terminal with the target transmission channel for communication. For example, the first preset device identity may be a 5G-satellite UE indication. Any satellite device with the function of allocating the first address to the satellite terminal and providing the satellite terminal with the target transmission channel for communication can carry the first preset device identity in the first channel establishment request message.

In some other embodiments, the above second channel establishment request message may include the first preset device identity.

In some other embodiments, the above first channel establishment request message and second channel establishment request message may each include a first preset device identity.

S1202: The SMF entity sends, in the case where the target transmission channel is successfully established, a third message to the AMF entity.

The third message is used to indicate the AMF entity to determine that the target transmission channel is successfully established, in order that facilitate the AMF entity sends a first channel establishment acceptance message to the satellite device through the access network device; the first channel establishment acceptance message is used to indicate the satellite device to determine the target transmission channel, determines, in response to receiving an access request message sent by the satellite terminal, a first address corresponding to the satellite terminal, and sends an access response message to the satellite terminal, where the access response message includes the first address, and is used to indicate the satellite terminal to access according to the first address to communicate through the target transmission channel; the target communication network is a network supporting a preset communication standard, and the satellite terminal is a terminal not supporting a preset communication standard.

With the above implementation, the SMF entity can establish, in response to receiving the second channel establishment request message, the target transmission channel between the satellite device and the target communication network, in order that facilitate the satellite device provides the satellite terminal with communication services through the target transmission channel.

In some embodiments of the present disclosure, the above second channel establishment request message includes an access type and/or RAT (Radio Access Type) type. The access type may be used to characterize the type of the satellite device or satellite terminal, and the RAT type may be used to characterize the communication standard supported by the satellite device or the communication standard supported by the satellite terminal.

In some embodiments, the above second channel establishment request message may include an access type, the access type may include a first access type or a second access type. The first access type may be used to characterize a non-3GPP type (e.g., the first access type may be Non-3GPP Access), and the second access type may be used to characterize a 3GPP type (e.g., the second access type may be 3GPP Access).

In some other embodiments, the above second channel establishment request message may include a RAT type, the RAT type may include a first RAT type or a second RAT type. The first RAT type may be used to characterize a satellite communication standard (e.g., the first RAT type may be Legacy Satellite), and the second RAT type may be used to characterize a target communication standard (e.g., the second RAT type may be 5G Satellite or NR Satellite).

In some other embodiments, the above second channel establishment request message may include an access type and a RAT type.

In an implementation, the first access type may be used to characterize a non-3GPP type (e.g., the first access type may be Non-3GPP Access), and the first RAT type may be used to characterize a satellite communication standard (e.g., the first RAT type may be Legacy Satellite).

In another implementation, the second access type may be used to characterize a 3GPP type (e.g., the second access type is 3GPP Access), and the second RAT type may be used to characterize a target communication standard (e.g., the second RAT type may be 5G Satellite or NR Satellite).

In this way, the SMF entity can determine, through the access type and/or RAT type in the above second channel establishment request message, the channel type of the target transmission channel to be established.

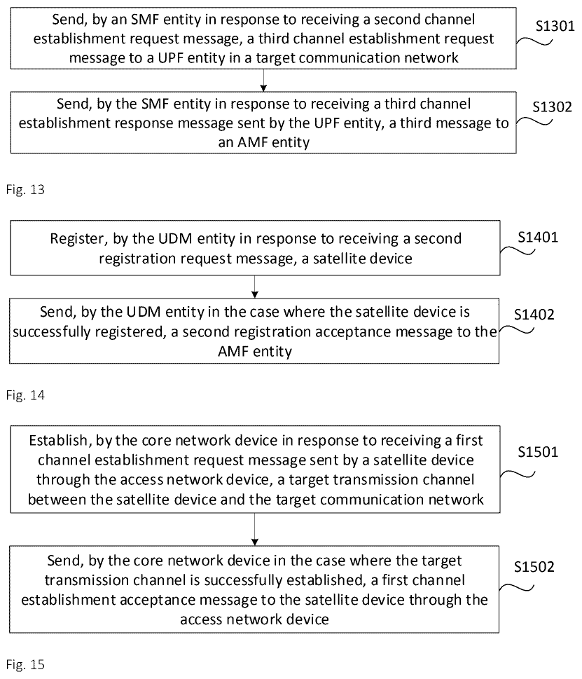

FIG. 13 is a satellite communication method as shown according to an example. As shown in FIG. 13, the method may include steps S1301 and S1302.

S1301: An SMF entity sends, in response to receiving a second channel establishment request message, a third channel establishment request message to a UPF entity in a target communication network.

In some embodiments, the third channel establishment request message may include a first preset device identity.

In some other embodiments, the third channel establishment request message may not include a first preset device identity.

S1302: The SMF entity sends, in response to receiving a third channel establishment response message sent by the UPF entity, a third message to an AMF entity.

The third message is used to indicate the AMF entity to determine that the target transmission channel is successfully established.

In some embodiments, the third channel establishment response message includes a second address allocated by the UPF entity to the satellite device.

For example, it may be determined, in response to receiving the third channel establishment response message sent by the UPF entity, that the target transmission channel is successfully established; and in response to determining that the target transmission channel is successfully established, the third message may be sent to the AMF entity.

With the above implementation, the SMF entity can establish, in response to receiving the second channel establishment request message, the target transmission channel between the satellite device and the target communication network by interacting with the UPF entity, in order that facilitate the satellite device provides a satellite terminal with communication services through the target transmission channel.

In some embodiments, the third channel establishment request message may further include a preset channel rule corresponding to the target transmission channel, and the preset channel rule may include a packet detection, enforcement and reporting rule.

In some embodiments, taking the target communication network being a 5G network as an example, the third channel establishment request message may be an N4 session establishment request message (e.g., N4 Session Establishment Request), and the third channel establishment response message may be an N4 session establishment response message (e.g., N4 Session Establishment Response).

FIG. 14 is a satellite communication method as shown according to an example. The method can be performed by a UDM entity in the above communication system, the UDM entity is an entity in a target communication network, and the target communication network may further include an access network device. As shown in FIG. 14, the method may include steps S1401 and S1402.

S1401: The UDM entity registers, in response to receiving a second registration request message, a satellite device.

The second registration request message is a message sent by an access and mobility management function (AMF) entity in the target communication network in response to receiving a first registration request message sent by the satellite device through the access network device.

S1402: The UDM entity sends, in the case where the satellite device is successfully registered, a second registration acceptance message to the AMF entity.

The second registration acceptance message is used to indicate the AMF entity to determine that the satellite device is successfully registered, in order that facilitate the AMF entity sends a first registration acceptance message to the satellite device through the access network device; and the first registration acceptance message is used to indicate that the satellite device is successfully registered in the target communication network, in order that facilitate the satellite device sends, in the case of a successful registration, a first channel establishment request message to a core network device through the access network device.

In some embodiments, the above first registration request message and second registration request message may each include a second preset device identity, the second preset device identity is used to indicate that the satellite device has a function to allocate a first address to a satellite terminal and provide the satellite terminal with the target transmission channel for communication.

It is to be noted that the second preset device identity may be the same as or different from the first preset device identity. For example, the second preset device identity may also be a 5G-satellite UE indication.

With the above implementation, the UDM entity can register, in response to receiving the second registration request message, the satellite device, in order that facilitate the AMF entity determines that the satellite device is successfully registered, thus providing the satellite terminal with communication services through the satellite device.

In some embodiments of the present disclosure, the UDM entity may further send, in response to receiving a subscription information request message sent by the AMF entity, subscription information for the satellite device to the AMF entity, where the subscription information request message is a message sent by the AMF entity without acquiring the subscription information for the satellite device.

For example, a subscription information response message may be sent to the AMF entity, where the subscription information response message includes the subscription information.

In some embodiments, the above first registration request message, second registration request message and subscription information request message may each include a second preset device identity.

In some other embodiments, one or more of the above first registration request message, second registration request message and subscription information request message carry the above second preset device identity. For example, merely the first registration request message carries the second preset device identity, or merely the first registration request message and the second registration request message carry the second preset device identity.

In some embodiments of the present disclosure, the UDM entity may store a second preset device identity corresponding to the satellite device. For example, the UDM entity may store the above second preset device identity in the subscription information for the satellite device.

In some implementations, the second preset device identity may be an identification parameter set by an operator when opening an account for the satellite device.

In some implementations, the UDM entity may determine, according to the subscription information for the satellite device and the above second registration request message, whether the satellite device is successfully registered. For example, if the second registration request message carries the above second preset device identity, and the subscription information for the satellite device does not include the above second preset device identity, it may be determined that the registration of the satellite device has failed; conversely, if both the second registration request message and the subscription information for the satellite device include the above second preset device identity, it may be determined that the satellite device is successfully registered.

FIG. 15 is a satellite communication method as shown according to an example. The method can be performed by a core network device in the above communication system, the core network device is a device in a target communication network, and the target communication network further includes an access network device. As shown in FIG. 15, the method may include steps S1501 and S1502.

S1501: The core network device establishes, in response to receiving a first channel establishment request message sent by a satellite device through the access network device, a target transmission channel between the satellite device and the target communication network.

S1502: The core network device sends, in the case where the target transmission channel is successfully established, a first channel establishment acceptance message to the satellite device through the access network device.

The first channel establishment acceptance message is used to indicate the satellite device to determine the target transmission channel, to determine, in response to receiving an access request message sent by a satellite terminal, a first address corresponding to a satellite terminal, and send an access response message to the satellite terminal, where the access response message includes the first address, and is used to indicate the satellite terminal to access according to the first address to communicate through the target transmission channel; the target communication network is a network supporting a preset communication standard, and the satellite terminal is a terminal not supporting a preset communication standard.

With the above implementation, the core network device can establish, in response to receiving the first channel establishment request message sent by the satellite device through the access network device, the target transmission channel for the satellite device, in order that facilitate the satellite device provides the satellite terminal with communication services through the target transmission channel.

In some embodiments, the above first channel establishment request message may include a first preset device identity, the first preset device identity is used to indicate that the satellite device has a function to allocate the first address to the satellite terminal and provide the satellite terminal with the target transmission channel for communication. For example, the first preset device identity may be a 5G-satellite UE indication. Any satellite device with the function of allocating the first address to the satellite terminal and providing the satellite terminal with the target transmission channel for communication can carry the first preset device identity in the first channel establishment request message.

In some embodiments, the above first channel establishment acceptance message may include a second address allocated by the core network device to the satellite device.

In some implementations, the second address may include an IP address and/or an IP address prefix.

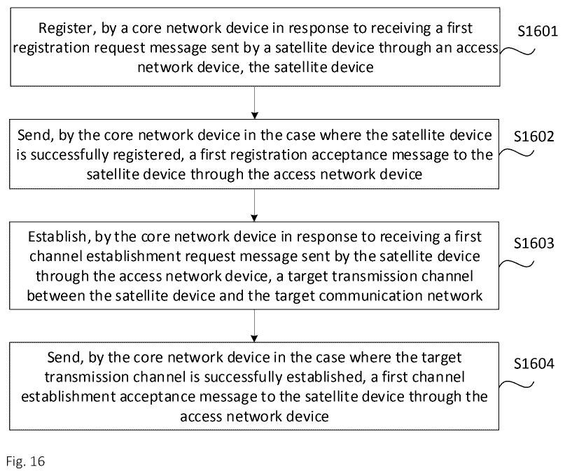

FIG. 16 is a satellite communication method as shown according to an example. As shown in FIG. 16, the method may include steps S1601-S1604.

S1601: A core network device registers, in response to receiving a first registration request message sent by a satellite device through an access network device, the satellite device.

S1602: The core network device sends, in the case where the satellite device is successfully registered, a first registration acceptance message to the satellite device through the access network device.

The first registration acceptance message is used to indicate that the satellite device is successfully registered in a target communication network, in order that facilitate the satellite device sends, in the case of a successful registration, a first channel establishment request message to the core network device through the access network device.

S1603: The core network device establishes, in response to receiving a first channel establishment request message sent by the satellite device through the access network device, a target transmission channel between the satellite device and the target communication network.

S1604: The core network device sends, in the case where the target transmission channel is successfully established, a first channel establishment acceptance message to the satellite device through the access network device.

With the above implementation, the core network device can register the satellite device and establish the target transmission channel, in order that facilitate the satellite device provides a satellite terminal with communication services through the target transmission channel.

In some embodiments, the first registration request message may include a second preset device identity, the second preset device identity is used to indicate that the satellite device has a function to allocate a first address to the satellite terminal and provide the satellite terminal with the target transmission channel for communication.

It is to be noted that the second preset device identity may be the same as or different from the first preset device identity. For example, the second preset device identity may also be a 5G-satellite UE indication.

In some embodiments of the present disclosure, a second preset device identity corresponding to the satellite device may be stored in the core network device. For example, the core network device may store the above second preset device identity in the subscription information for the satellite device.

In some implementations, the second preset device identity may be an identification parameter set by the operator when opening an account for the satellite device.

In some implementations, the core network device may determine, according to the subscription information for the satellite device and the above second registration request message, whether the satellite device is successfully registered. For example, if the second registration request message carries the above second preset device identity, and the subscription information for the satellite device does not include the above second preset device identity, it may be determined that the registration of the satellite device has failed; conversely, if both the second registration request message and the subscription information for the satellite device include the above second preset device identity, it may be determined that the satellite device is successfully registered.

In some embodiments of the present disclosure, the core network device may include the above AMF entity, SMF entity, UDM entity, and UPF entity. The satellite communication method in this embodiment can be comprehensively implemented by the AMF entity, SMF entity, UDM entity, and UPF entity, and the specific implementation of the related steps in the satellite communication method can refer to the implementations of the AMF entity, SMF entity, UDM entity and UPF entity in the previous embodiments of the present disclosure, and will not be detailed herein.

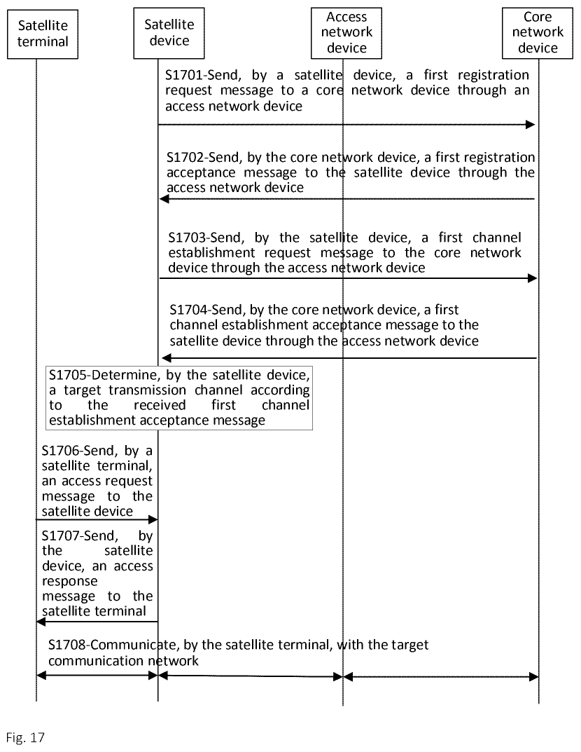

FIG. 17 is a satellite communication method as shown according to an example. As shown in FIG. 17, the method may include steps S1701-S1708.

S1701: A satellite device sends a first registration request message to a core network device through an access network device.

S1702: The core network device sends a first registration acceptance message to the satellite device through the access network device.

For example, the core network device may register, in response to receiving the first registration request message sent by the satellite device through the access network device, the satellite device, and send, in the case where the satellite device is successfully registered, the first registration acceptance message to the satellite device through the access network device.

The first registration acceptance message may be used to indicate that the satellite device is successfully registered in the target communication network.

S1703: The satellite device sends a first channel establishment request message to the core network device through the access network device.

For example, the satellite device may determine, according to a received first registration acceptance message, that the satellite device is successfully registered in the target communication network, and send a first channel establishment request message to the core network device through the access network device.

S1704: The core network device sends a first channel establishment acceptance message to the satellite device through the access network device.

For example, the core network device may establish, in response to receiving the first channel establishment request message sent by the satellite device through the access network device, a target transmission channel between the satellite device and the target communication network.

S1705: The satellite device determines a target transmission channel according to the received first channel establishment acceptance message.

S1706: A satellite terminal sends an access request message to the satellite device.

S1707: The satellite device sends an access response message to the satellite terminal.

For example, the satellite device may determine, in response to receiving the access request message sent by the satellite terminal, a first address corresponding to the satellite terminal, and send the access response message to the satellite terminal.

S1708: The satellite terminal communicates with the target communication network.

For example, the satellite terminal may communicate through the target transmission channel between the satellite device and the target communication network according to the first address.

In some embodiments, the target communication network may be a network supporting a preset communication standard, and the satellite terminal may be a terminal not supporting a preset communication standard.

In some other embodiments, the target communication network and the satellite terminal may each support a preset communication standard.

The preset communication standard may include 4G, 5G or other future wireless communication standards (such as 6G).

In some embodiments, before the above step S1701, the access network device may establish a second interface with the core network device. For example, the access network device may send a second interface establishment request message to the core network device, and the core network device may send a second interface establishment acceptance message to the access network device in response to the second interface establishment request message, thus accomplishing the establishment of the second interface (e.g., N2 interface).

It is to be noted that the specific implementation of the above steps in this embodiment can refer to the description in the previous embodiments of the present disclosure, and will not be detailed herein. The above satellite terminal, satellite device, access network device and core network device can refer to the illustration in the communication system as shown in FIG. 1, and will not be detailed herein, either.

With the above implementation, the satellite device can register and establish a target transmission channel, in order to provide the satellite terminal with communication services through the target transmission channel.

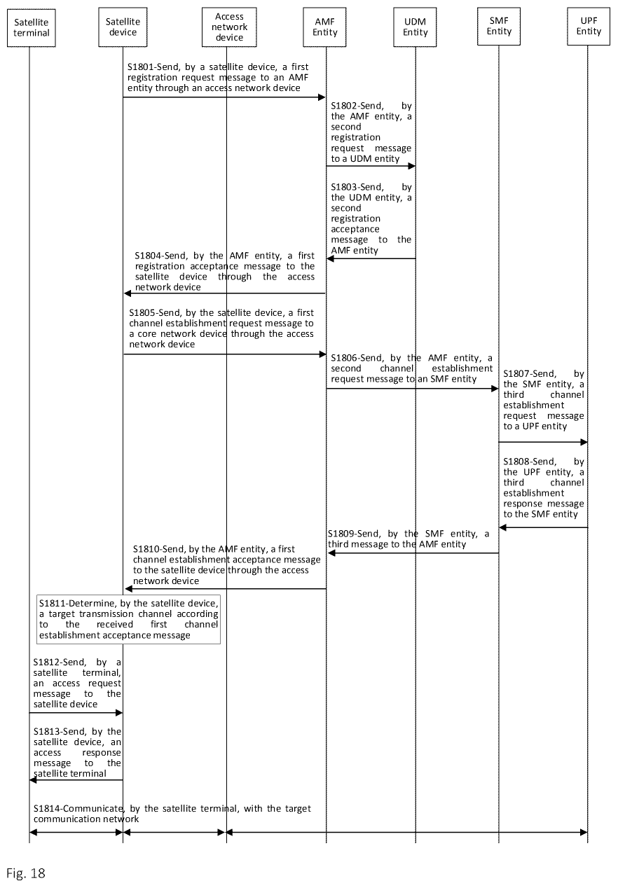

FIG. 18 is a satellite communication method as shown according to an example. As shown in FIG. 18, the method may include steps S1801-S1814.

S1801: A satellite device sends, a first registration request message to an AMF entity through an access network device.

S1802: The AMF entity sends a second registration request message to a UDM entity.

For example, the AMF entity may send, in response to receiving the first registration request message sent by the satellite device through the access network device, the second registration request message to a unified data management (UDM) entity in a target communication network.

S1803: The UDM entity sends a second registration acceptance message to the AMF entity.

For example, the UDM entity may register, in response to receiving the second registration request message, the satellite device; and sends, in the case where the satellite device is successfully registered, the second registration acceptance message to the AMF entity.

S1804: The AMF entity sends a first registration acceptance message to the satellite device through the access network device.

For example, the AMF entity may send, in response to receiving the second registration acceptance message sent by the UDM entity, the first registration acceptance message to the satellite device through the access network device.

The first registration acceptance message may be used to indicate that the satellite device is successfully registered in the target communication network.

S1805: The satellite device sends a first channel establishment request message to a core network device through the access network device.

For example, the satellite device may determine, according to a received first registration acceptance message, that the satellite device is successfully registered in the target communication network, and send a first channel establishment request message to the core network device through the access network device.

S1806: The AMF entity sends a second channel establishment request message to an SMF entity.

For example, the AMF entity may send, in response to receiving the first channel establishment request message sent by the satellite device through the access network device, the second channel establishment request message to a session management function (SMF) entity in the target communication network.

S1807: The SMF entity sends a third channel establishment request message to a UPF entity.

For example, the SMF entity may send, in response to receiving the second channel establishment request message, the third channel establishment request message to a user plane function (UPF) entity in the target communication network.

S1808: The UPF entity sends, a third channel establishment response message to the SMF entity.

For example, the UPF entity may send, according to the received second channel establishment request message, the third channel establishment response message to the SMF entity in the case where a target transmission channel is successfully established for the satellite device.

S1809: The SMF entity sends a third message to the AMF entity.

For example, the SMF entity may send, in response to receiving the third channel establishment response message sent by the UPF entity, the third message to the AMF entity.

S1810: The AMF entity sends a first channel establishment acceptance message to the satellite device through the access network device.

For example, the AMF entity may send, in response to receiving the third message sent by the SMF entity, the first channel establishment acceptance message to the satellite device through the access network device.

S1811: The satellite device determines a target transmission channel according to the received first channel establishment acceptance message.

S1812: The satellite terminal sends an access request message to the satellite device.

S1813: The satellite device sends an access response message to the satellite terminal.

For example, the satellite device may determine, in response to receiving the access request message sent by the satellite terminal, a first address corresponding to the satellite terminal, and send the access response message to the satellite terminal.

S1814: The satellite terminal communicates with the target communication network.

For example, the satellite terminal may communicate through the target transmission channel between the satellite device and the target communication network according to the first address.

In some embodiments, the target communication network may be a network supporting a preset communication standard, and the satellite terminal may be a terminal not supporting a preset communication standard.

In some other embodiments, the target communication network and the satellite terminal may each support a preset communication standard.

The preset communication standard may include 4G, 5G or other future wireless communication standards (such as 6G).

In some embodiments, before the above step S1801, the access network device may establish a second interface with the AMF entity. For example, the access network device may send a second interface establishment request message to the AMF entity, and the AMF entity may send a second interface establishment acceptance message to the access network device in response to the second interface establishment request message, thus accomplishing the establishment of the second interface (e.g., N2 interface).

It is to be noted that the specific implementation of the above steps in this embodiment can refer to the description in the previous embodiments of the present disclosure, and will not be detailed herein. The above satellite terminal, satellite device, access network device, AMF entity, SMF entity, UDM entity and UPF entity can refer to the illustration in the communication system as shown in FIG. 2, and will not be detailed herein, either.

With the above implementation, the satellite device can register and establish a target transmission channel, in order to provide the satellite terminal with communication services through the target transmission channel.

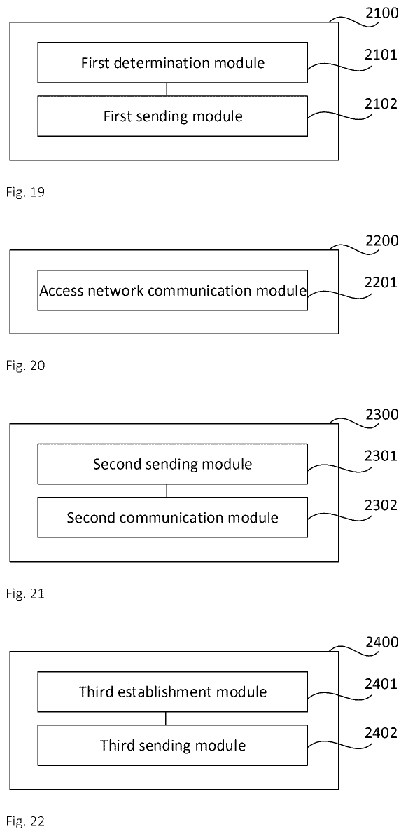

FIG. 19 is a block diagram of a satellite communication device 2100 as shown according to an example. The device can be performed by a satellite device in the above communication system. As shown in FIG. 19, the satellite communication device 2100 may include:
a first determination module 2101, configured to determine, in response to receiving an access request message sent by the satellite terminal, a first address corresponding to a satellite terminal; and
a first sending module 2102, configured to send an access response message to the satellite terminal, where the access response message includes the first address and is used to indicate the satellite terminal to communicate through a target transmission channel according to the first address, the target transmission channel is a channel between the satellite device and a target communication network, the target communication network is a network supporting a preset communication standard, and the satellite terminal is a terminal not supporting a preset communication standard.

In some embodiments, the target communication network includes an access network device and a core network device. The first determination module 2101 is configured to: send a first channel establishment request message to the core network device through the access network device; and determine the target transmission channel according to a received first channel establishment acceptance message, where the first channel establishment acceptance message is a message sent by the core network device through the access network device after the target transmission channel is successfully established for the satellite device in response to the first channel establishment request message.

In some embodiments, the first channel establishment request message includes a first preset device identity, the first preset device identity is used to indicate that the satellite device has a function to allocate the first address to the satellite terminal and provide the satellite terminal with the target transmission channel for communication.

In some embodiments, the first channel establishment acceptance message includes a second address allocated by the core network device to the satellite device; and
the first determination module 2101 is configured to allocating the first address to the satellite terminal according to the second address, where the first address is different from the second address.

In some embodiments, the second address includes an IP address and/or an IP address prefix.

In some embodiments, the first address is a local IP address or a private IP address.

In some embodiments, the target transmission channel is a data transmission channel based on a protocol data unit (PDU) session, the first channel establishment request message is a first PDU session establishment request message, and the first channel establishment acceptance message is a first PDU session establishment acceptance message.

In some embodiments, the first sending module 2102 is configured to: send a first registration request message to the core network device through the access network device; determine that the satellite device is successfully registered in the target communication network according to a received first registration acceptance message, where the first registration acceptance message is a message sent by the core network device to the satellite device through the access network device after the satellite device is successfully registered in response to the first registration request message; and send the first channel establishment request message to the core network device through the access network device in response to determining that the satellite device is successfully registered in the target communication network.

In some embodiments, the first registration request message includes a second preset device identity, the second preset device identity is used to indicate that the satellite device has a function to allocate the first address to the satellite terminal and provide the satellite terminal with the target transmission channel for communication.

In some embodiments, the access network device includes a satellite access gateway function (S-AGF) entity, and the core network device includes an access and mobility management function (AMF) entity.

FIG. 20 is a block diagram of a satellite communication device 2200 as shown according to an example. The device can be performed by an access network device in a target communication network in the above communication system, and the target communication network further includes a core network device. As shown in FIG. 20, the satellite communication device 2200 may include:
an access network communication module 2201, configured to forward messages for communication between a satellite device and the core network device, in order that facilitate the satellite device establishes a target transmission channel with the target communication network, determines, in response to receiving an access request message sent by a satellite terminal, a first address corresponding to the satellite terminal, and sends an access response message to the satellite terminal, where the access response message includes the first address, and is used to indicate the satellite terminal to access the target communication network according to the first address and communicate based on the target transmission channel; the target communication network is a network supporting a preset communication standard, and the satellite terminal is a terminal not supporting a preset communication standard.

In some embodiments, the access network communication module 2201 is configured to: forward, in response to receiving a first message sent by the satellite device, the first message to the core network device in the target communication network, where the first message includes a first registration request message and/or a first channel establishment request message; or forward, in response to receiving a second message sent by the core network device, the second message to the satellite device, where the second message includes a first registration acceptance message and/or a first channel establishment acceptance message.

In some embodiments, the access network communication module 2201 is further configured to: send a second interface establishment request message to the core network device; and establish a second interface with the core network device according to a received second interface establishment acceptance message, where the second interface establishment acceptance message is a message sent by the core network device in response to the second interface establishment request message.

In some embodiments, the core network device includes an access and mobility management function (AMF) entity, and the second interface is an interface between the access network device and the AMF entity.

In some embodiments, the access network device includes a satellite access gateway function (S-AGF) entity, and the second interface establishment request message includes a gateway node indication, the gateway node indication is used to indicate the access network device provides a gateway function for the satellite device.

FIG. 21 is a block diagram of a satellite communication device 2300 as shown according to an example. The device can be performed by an access and mobility management function (AMF) entity, the AMF entity is an entity in the target communication network, and the target communication network further includes an access network device. As shown in FIG. 21, the satellite communication device 2300 may include:
a second sending module 2301, configured to send, in response to receiving a first channel establishment request message sent by a satellite device through the access network device, a second channel establishment request message to a session management function (SMF) entity in the target communication network; and
a second communication module 2302, configured to send, in response to receiving a third message sent by the SMF entity, a first channel establishment acceptance message to the satellite device through the access network device, where the third message is a message sent by the SMF entity after a target transmission channel between the satellite device and the target communication network is established in response to the second channel establishment request message; the first channel establishment acceptance message is used to indicate the satellite device to determine the target transmission channel, to determine, in response to receiving an access request message sent by a satellite terminal, a first address corresponding to the satellite terminal, and to send an access response message to the satellite terminal, where the access response message includes the first address, and is used to indicate the satellite terminal to access according to the first address to communicate through the target transmission channel; the target communication network is a network supporting a preset communication standard, and the satellite terminal is a terminal not supporting a preset communication standard.

In some embodiments, the first channel establishment request message and the second channel establishment request message each include a first preset device identity, the first preset device identity is used to indicate that the satellite device has a function to allocate the first address to the satellite terminal and provide the satellite terminal with the target transmission channel for communication.

In some embodiments, the third message and the first channel establishment acceptance message each include a second address allocated by a core network device to the satellite device.

In some embodiments, the target transmission channel is a data transmission channel based on a protocol data unit (PDU) session, the first channel establishment request message is a first PDU session establishment request message, the first channel establishment acceptance message is a first PDU session establishment acceptance message, the second channel establishment request message is a second PDU session establishment request message, and the second channel establishment acceptance message is a second PDU session establishment acceptance message.

In some embodiments, the second sending module 2301 is further configured to: send, in response to receiving a first registration request message sent by the satellite device through the access network device, a second registration request message to a unified data management (UDM) entity in the target communication network; and send, in response to receiving a second registration acceptance message sent by the UDM entity, a first registration acceptance message to the satellite device through the access network device, where the second registration acceptance message is a message sent by the UDM entity in the case where the satellite device is successfully registered in response to the second registration request message; the first registration acceptance message is used to indicate that the satellite device is successfully registered in the target communication network, in order that facilitate the satellite device sends, in the case of a successful registration, the first channel establishment request message to a core network device through the access network device.

In some embodiments, the second sending module 2301 is further configured to: send, in the case where no subscription information for the satellite device is acquired by the AMF entity, a subscription information request message to the UDM entity; and acquire, in response to receiving a subscription information response message sent by the UDM entity, subscription information for the satellite device, where the subscription information response message is a message sent by the UDM entity in response to the subscription information request message.

In some embodiments, the first registration request message, the second registration request message and the subscription information request message each include a second preset device identity, the second preset device identity is used to indicate that the satellite device has a function to allocate the first address to the satellite terminal and provide the satellite terminal with the target transmission channel for communication.

In some embodiments, the second sending module 2301 is further configured to send, in response to receiving a second interface establishment request message sent by the access network device, a second interface establishment acceptance message to the access network device, where the access network device includes an S-AGF entity, and the second interface establishment request message includes a gateway node indication, the gateway node indication is used to indicate the access network device provides a gateway function for the satellite device.

FIG. 22 is a block diagram of a satellite communication device 2400 as shown according to an example. The device can be performed by a session management function (SMF) entity, the SMF entity is an entity in a target communication network, and the target communication network further includes an access network device. As shown in FIG. 22, the satellite communication device 2400 may include:
a third establishment module 2401, configured to establishing, in response to receiving a second channel establishment request message, a target transmission channel between a satellite device and the target communication network, where the second channel establishment request message is a message sent by an access and mobility management function (AMF) entity in the target communication network in response to receiving a first channel establishment request message sent by the satellite device through the access network device, for establishing the target transmission channel between the satellite device and the target communication network; and
a third sending module 2402, configured to send, in the case where the target transmission channel is successfully established, a third message to the AMF entity, where the third message is used to indicate the AMF entity to determine that the target transmission channel is successfully established, in order that facilitate the AMF entity sends a first channel establishment acceptance message to the satellite device through the access network device; the first channel establishment acceptance message is used to indicate the satellite device to determine the target transmission channel, determines, in response to receiving an access request message sent by a satellite terminal, a first address corresponding to the satellite terminal, and sends an access response message to the satellite terminal, where the access response message includes the first address, and is used to indicate the satellite terminal to access according to the first address to communicate through the target transmission channel; the target communication network is a network supporting a preset communication standard, and the satellite terminal is a terminal not supporting a preset communication standard.

In some embodiments, the first channel establishment request message and the second channel establishment request message each include a first preset device identity, the first preset device identity is used to indicate that the satellite device has a function to allocate the first address to the satellite terminal and provide the satellite terminal with the target transmission channel for communication.

In some embodiments, the third establishment module 2401 is configured to send a third channel establishment request message to a user plane function (UPF) entity in the target communication network; and determine, in response to receiving a third channel establishment response message sent by the UPF entity, that the target transmission channel is successfully established.

In some embodiments, the third channel establishment response message includes a second address allocated by the UPF entity to the satellite device.

In some embodiments, the third channel establishment request message includes the first preset device identity.

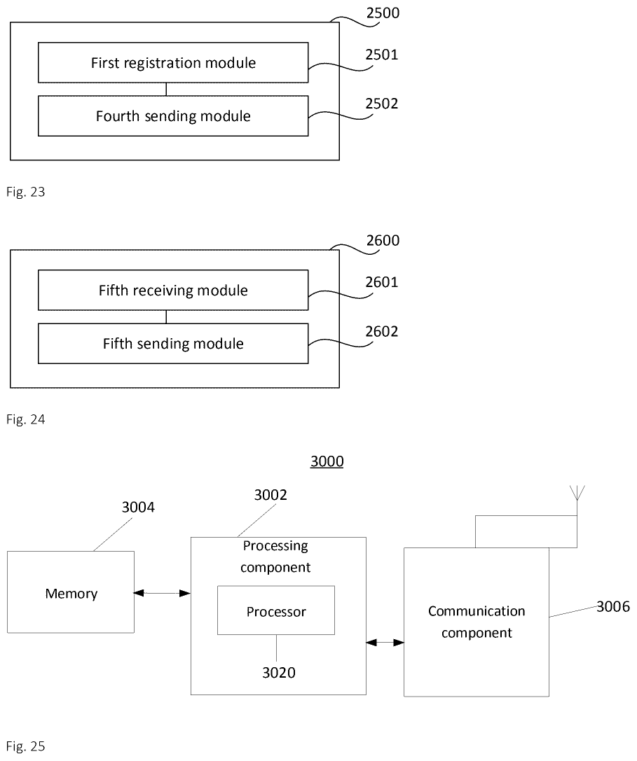

FIG. 23 is a block diagram of a satellite communication device 2500 as shown according to an example. The device can be performed by a unified data management (UDM) entity, the UDM entity is an entity in a target communication network, and the target communication network further includes an access network device. As shown in FIG. 23, the satellite communication device 2500 may include:
a first registration module 2501, configured to register, in response to receiving a second registration request message, a satellite device, where the second registration request message is a message sent by an access and mobility management function (AMF) entity in the target communication network in response to receiving a first registration request message sent by the satellite device through the access network device; and
a fourth sending module 2502, configured to send, in the case where the satellite device is successfully registered, a second registration acceptance message to the AMF entity, where the second registration acceptance message is used to indicate the AMF entity to determine that the satellite device is successfully registered, in order that facilitate the AMF entity sends a first registration acceptance message to the satellite device through the access network device; and the first registration acceptance message is used to indicate that the satellite device is successfully registered in the target communication network, in order to facilitate the satellite device sends, in the case of a successful registration, a first channel establishment request message to a core network device through the access network device.

In some embodiments, the fourth sending module 2502 is configured to send, in response to receiving a subscription information request message sent by the AMF entity, subscription information for the satellite device to the AMF entity, where the subscription information request message is a message sent by the AMF entity without acquiring the subscription information for the satellite device.

In some embodiments, the first registration request message, the second registration request message and the subscription information request message each include a second preset device identity, the second preset device identity is used to indicate that the satellite device has a function to allocate a first address to a satellite terminal and provide the satellite terminal with a target transmission channel for communication.

In some embodiments, a second preset device identity corresponding to the satellite device is stored in the UDM entity.

FIG. 24 is a block diagram of a satellite communication device 2600 as shown according to an example. The device can be performed by a core network device, the core network device is a device in a target communication network, and the target communication network further includes an access network device. As shown in FIG. 24, the satellite communication device 2600 may include:
a fifth receiving module 2601, configured to establish, in response to receiving a first channel establishment request message sent by a satellite device through the access network device, a target transmission channel between the satellite device and the target communication network; and
a fifth sending module 2602, configured to send, in the case where the target transmission channel is successfully established, a first channel establishment acceptance message to the satellite device through the access network device, where the first channel establishment acceptance message is used to indicate the satellite device to determine the target transmission channel, to determine, in response to receiving an access request message sent by a satellite terminal, a first address corresponding to the satellite terminal, and to send an access response message to the satellite terminal, where the access response message includes the first address, and is used to indicate the satellite terminal to access according to the first address to communicate through the target transmission channel; the target communication network is a network supporting a preset communication standard, and the satellite terminal is a terminal not supporting a preset communication standard.

In some embodiments, the first channel establishment request message includes a first preset device identity, the first preset device identity is used to indicate that the satellite device has a function to allocate the first address to the satellite terminal and provide the satellite terminal with the target transmission channel for communication.

In some embodiments, the first channel establishment acceptance message includes a second address allocated by the core network device to the satellite device.

In some embodiments, the fifth sending module 2602 is configured to: register, in response to receiving a first registration request message sent by the satellite device through the access network device, the satellite device; and send, in the case where the satellite device is successfully registered, a first registration acceptance message to the satellite device through the access network device, where the first registration acceptance message is used to indicate that the satellite device is successfully registered in the target communication network, where facilitate the satellite device sends, in the case of a successful registration, the first channel establishment request message to the core network device through the access network device.

In some embodiments, the first registration request message includes a second preset device identity, the second preset device identity is used to indicate that the satellite device has a function to allocate the first address to the satellite terminal and provide the satellite terminal with the target transmission channel for communication.

With regard to the device in the above embodiments, the implementations in which the respective modules perform operations have been described in detail in the embodiments with respect to the method, and will not be detailed herein.

FIG. 25 is a block diagram of a satellite communication device as shown according to an example. The satellite communication device 3000 can be a satellite device, an access network device, or a core network device in the communication system as shown in FIG. 1, or can be any entity in the communication system as shown in FIG. 2, such as an S-AGF entity, an AMF entity, an SMF entity, a UDM entity, or a UPF entity.

Referring to FIG. 25, the satellite communication device 3000 may include any one or more of components as follows: a processing component 3002, a memory 3004, and a communication component 3006.

The processing component 3002 may be used to control the overall operation of the satellite communication device 3000, such as operations associated with display, telephone call, data communication, camera operation and recording operation. The processing component 3002 may include one or more processors 3020 to execute instructions in order to accomplish all or part of the steps of the above satellite communication method. In addition, the processing component 3002 may include one or more modules to facilitate interaction between the processing component 3002 and other components. For example, the processing component 3002 may include a multimedia module to facilitate interaction between a multimedia component and the processing component 3002.

The memory 3004 is configured to store various types of data to support operations in the satellite communication device 3000. Examples of such data include instructions for any application or method operating on the satellite communication device 3000, such as contact data, phone book data, messages, pictures, and videos. The memory 3004 can be implemented by any type of volatile or nonvolatile memory devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 3006 is configured to facilitate communication between the satellite communication device 3000 and other devices by wired or wireless means. The satellite communication device 3000 can access communication standard-based wireless networks, such as Wi-Fi, 2G, 3G, 4G, 5G, 6G, NB-IOT, and eMTC, or a combination thereof. In an example, the communication component 3006 receives a broadcast signal or broadcast related information from an external broadcast management system via a broadcast channel. In an example, the communication component 3006 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology, and other technologies.

In an example, the satellite communication device 3000 can be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements, for performing the above satellite communication methods.

The satellite communication device 3000 can be an independent electronic device, or can be a part of an independent electronic device. For example, in an embodiment, the electronic device can be an integrated circuit (IC) or a chip, where the integrated circuit can be one IC, or can be a set of a plurality of ICs. The chip may include, but is not limited to the following types: GPU (Graphics Processing Unit), CPU (Central Processing Unit), FPGA (Field Programmable Gate Array), DSP (Digital Signal Processor), ASIC (Application Specific Integrated Circuit), SoC (System on Chip), and the like. The above integrated circuit or chip may be used to execute executable instructions (or codes) to implement the above satellite communication methods. The executable instructions may be stored in the integrated circuit or chip, or may be acquired from other devices or devices. For example, the integrated circuit or chip includes a processor, a memory, and an interface for communicating with other devices. The executable instructions may be stored in the processor. When the executable instructions are executed by the processor, the above satellite communication methods are implemented. Or, the integrated circuit or chip may receive executable instructions through the interface and transmit the executable instructions to the processor for execution, in order to implement the above satellite communication methods.

In an example, the present disclosure further provides a computer-readable storage medium having stored thereon computer program instructions. When the program instructions are executed by a processor, the steps of the satellite communication methods as provided by the present disclosure are implemented. For example, the computer-readable storage medium can be a non-transitory computer-readable storage medium including instructions, such as the above memory 3004 including instructions. The above instructions may be executed by the processor 3020 of the satellite communication device 3000 in order to accomplish the above satellite communication methods. For example, the non-transitory computer-readable storage medium can be ROM, random access memory (RAM), CD-ROM, magnetic tape, floppy disk, optical data storage device, and the like.

In another example, a computer program product containing a computer program executable by a programmable device is also provided. The computer program has a code portion which, when executed by the programmable device, performs the above satellite communication methods.

Other implementations of the present disclosure will readily conceivable to those skilled in the art after considering the specification and practicing the present disclosure. The present disclosure is intended to encompass any variations, usages or adaptations of the present disclosure, and such variations, usages or adaptations follow the general principles of the present disclosure and include common general knowledge or conventional technical means in this technical field that are not disclosed by the present disclosure. The specification and the embodiments are to be regarded as exemplary merely, with the true scope and spirit of the present disclosure being indicated by the appended claims.

It is to be understood that the present disclosure is not limited to the precise structure having been described above and shown in the accompanying drawings, and various modifications and changes can be made without departing from the scope thereof. The scope of the present disclosure is limited merely by the appended claims.

1. A satellite communication method, performed by a satellite device, the satellite communication method comprising:
determining, in a case where receiving an access request message sent by a satellite terminal, a first address corresponding to the satellite terminal; and
sending an access response message to the satellite terminal, wherein the access response message comprises the first address and is used to indicate the satellite terminal to communicate through a target transmission channel according to the first address, the target transmission channel is a channel between the satellite device and a target communication network, the target communication network is a network supporting a preset communication standard, and the satellite terminal is a terminal not supporting a preset communication standard.

2. The satellite communication method according to claim 1, wherein the target communication network comprises an access network device and a core network device; and wherein the target transmission channel is determined by:
sending a first channel establishment request message to the core network device through the access network device; and
determining the target transmission channel according to a received first channel establishment acceptance message, wherein the first channel establishment acceptance message is a message sent by the core network device through the access network device after the target transmission channel is successfully established for the satellite device in response to the first channel establishment request message.

3. (canceled)

4. The satellite communication method according to claim 2, wherein the first channel establishment acceptance message comprises a second address allocated by the core network device to the satellite device; and
determining the first address corresponding to the satellite terminal comprises:
allocating the first address to the satellite terminal according to the second address, wherein the first address is different from the second address.

5. The satellite communication method according to claim 4, wherein the second address comprises at least one of an IP address or an IP address prefix, and the first address is a local IP address or a private IP address.

6-7. (canceled)

8. The satellite communication method according to claim 2, further comprising:
sending a first registration request message to the core network device through the access network device;
determining that the satellite device is successfully registered in the target communication network according to a received first registration acceptance message, wherein the first registration acceptance message is a message sent by the core network device to the satellite device through the access network device after the satellite device is successfully registered in response to the first registration request message; and
sending the first channel establishment request message to the core network device through the access network device comprises:
sending the first channel establishment request message to the core network device through the access network device in a case where determining that the satellite device is successfully registered in the target communication network.

9-10. (canceled)

11. A satellite communication method, teperformed by an access network device in a target communication network, wherein the target communication network further comprises a core network device, the satellite communication method comprising:
forwarding messages for communication between a satellite device and the core network device, in order that the satellite device establishes a target transmission channel with the target communication network, determines, in a case where receiving an access request message sent by a satellite terminal, a first address corresponding to the satellite terminal, and sends an access response message to the satellite terminal, wherein the access response message comprises the first address, and is used to indicate the satellite terminal to access the target communication network according to the first address and communicate based on the target transmission channel; and wherein the target communication network is a network supporting a preset communication standard, and the satellite terminal is a terminal not supporting a preset communication standard.

12. The satellite communication method according to claim 11, wherein forwarding messages for communication between the satellite device and the core network device comprises:
forwarding, in a case where receiving a first message sent by the satellite device, the first message to the core network device in the target communication network, wherein the first message comprises at least one of a first registration request message or a first channel establishment request message; or
forwarding, in a case where receiving a second message sent by the core network device, the second message to the satellite device, wherein the second message comprises at least one of a first registration acceptance message or a first channel establishment acceptance message.

13. The satellite communication method according to claim 11, further comprising:
sending a second interface establishment request message to the core network device; and
establishing a second interface with the core network device according to a received second interface establishment acceptance message, wherein the second interface establishment acceptance message is a message sent by the core network device in response to the second interface establishment request message.

14. The satellite communication method according to claim 13, wherein the core network device comprises an access and mobility management function (AMF) entity, and the second interface is an interface between the access network device and the AMF entity, and the access network device comprises a satellite access gateway function (S-AGF) entity, and the second interface establishment request message comprises a gateway node indication, the gateway node indication is used to indicate the access network device provides a gateway function for the satellite device.

15. (canceled)

16. A satellite communication method, performed by an access and mobility management function (AMF) entity, wherein the AMF entity is an entity in a target communication network and the target communication network comprises an access network device, the satellite communication method comprising:
sending, in a case where receiving a first channel establishment request message sent by a satellite device through the access network device, a second channel establishment request message to a session management function (SMF) entity in the target communication network; and
sending, in a case where receiving a third message sent by the SMF entity, a first channel establishment acceptance message to the satellite device through the access network device, wherein the third message is a message sent by the SMF entity after a target transmission channel between the satellite device and the target communication network is established in response to the second channel establishment request message; the first channel establishment acceptance message is used to indicate the satellite device to determine the target transmission channel, to determine, in a case where receiving an access request message sent by a satellite terminal, a first address corresponding to the satellite terminal, and to send an access response message to the satellite terminal, wherein the access response message comprises the first address, and is used to indicate the satellite terminal to access according to the first address to communicate through the target transmission channel; the target communication network is a network supporting a preset communication standard, and the satellite terminal is a terminal not supporting a preset communication standard.

17. The satellite communication method according to claim 16, wherein the first channel establishment request message and the second channel establishment request message each comprise a first preset device identity, the first preset device identity is used to indicate that the satellite device has a function to allocate the first address to the satellite terminal and provide the satellite terminal with the target transmission channel for communication.

18. The satellite communication method according to claim 16, wherein the third message and the first channel establishment acceptance message each comprise a second address allocated by a core network device to the satellite device.

19. The satellite communication method according to claim 16, wherein the target transmission channel is a data transmission channel based on a protocol data unit (PDU) session, the first channel establishment request message is a first PDU session establishment request message, the first channel establishment acceptance message is a first PDU session establishment acceptance message, the second channel establishment request message is a second PDU session establishment request message, and the second channel establishment acceptance message is a second PDU session establishment acceptance message.

20. The satellite communication method according to claim 16, further comprising:
sending, in a case where receiving a first registration request message sent by the satellite device through the access network device, a second registration request message to a unified data management (UDM) entity in the target communication network; and
sending, in a case where receiving a second registration acceptance message sent by the UDM entity, a first registration acceptance message to the satellite device through the access network device, wherein the second registration acceptance message is a message sent by the UDM entity in a case where the satellite device is successfully registered in response to the second registration request message; the first registration acceptance message is used to indicate that the satellite device is successfully registered in the target communication network, in order that facilitate the satellite device, in a case of a successful registration, sends the first channel establishment request message to a core network device through the access network device.

21. The satellite communication method according to claim 20, wherein in the case where the second registration acceptance message sent by the UDM entity is received, the method further comprises:
sending, in a case where no subscription information for the satellite device is acquired by the AMF entity, a subscription information request message to the UDM entity; and
acquiring, in a case where receiving a subscription information response message sent by the UDM entity, subscription information for the satellite device, wherein the subscription information response message is a message sent by the UDM entity in response to the subscription information request message.

22. The satellite communication method according to claim 21, wherein the first registration request message, the second registration request message and the subscription information request message each comprise a second preset device identity, the second preset device identity is used to indicate that the satellite device has a function to allocate the first address to the satellite terminal and provide the satellite terminal with the target transmission channel for communication, wherein a second preset device identity corresponding to the satellite device is stored in the UDM entity.

23. The satellite communication method according to claim 16, further comprising:
sending, in a case where receiving a second interface establishment request message sent by the access network device, a second interface establishment acceptance message to the access network device, wherein the access network device comprises a satellite access gateway function (S-AGF) entity, and the second interface establishment request message comprises a gateway node indication, the gateway node indication is used to indicate the access network device provides a gateway function for the satellite device.

24-43. (canceled)

44. A satellite communication device, comprising:
a processor; and
a memory for storing processor-executable instructions;
wherein the processor is configured to execute the processor-executable instructions to perform the satellite communication method according to claim 1.

45-46. (canceled)

47. A satellite communication device, comprising:
a processor; and
a memory for storing processor-executable instructions;
wherein the processor is configured to execute the processor-executable instructions to perform the satellite communication method according to claim 11.

48. A satellite communication device, comprising:
a processor; and
a memory for storing processor-executable instructions;
wherein the processor is configured to execute the processor-executable instructions to perform the satellite communication method according to claim 16.
